(19) United States
(12) Patent Application Publication
(10) Pub. No.: US 2017/0245289 A1
(43) Pub. Date: Aug. 24, 2017

(54) LIMITS ON AGGREGATED MEDIA ACCESS CONTROL SERVICE DATA UNITS

(71) Applicants: Laurent Cariou, Portland, OR (US); Yaron Alpert, Hod Hasharoni (IL); Robert J. Stacey, Portland, OR (US)

(72) Inventors: Laurent Cariou, Portland, OR (US); Yaron Alpert, Hod Hasharoni (IL); Robert J. Stacey, Portland, OR (US)

(21) Appl. No.: 15/391,663

(22) Filed: Dec. 27, 2016

Related U.S. Application Data
(60) Provisional application No. 62/296,811, filed on Feb. 18, 2016.
(60) Provisional application No. 62/318,460, filed on Apr. 5, 2016.

(51) Int. Cl. H04W 72/08; H04L 29/08; H04L 5/00

(52) U.S. Cl. CPC H04W 72/085; H04L 5/0055; H04L 69/324; H04W 88/08

(57) ABSTRACT

Methods, apparatuses, computer readable media for limits on aggregated media access control (MAC) service data units (MSDU). An apparatus of an access point comprising processing circuitry is disclosed. The processing circuitry configured to encode a trigger frame comprising uplink resource allocations for stations, and configure the access point to transmit the trigger frame to the stations. The processing circuitry may be further configured to decode physical (PHY) layer convergence procedure (PLCP) protocol data unit (PPDUs) from the stations in accordance with the uplink resource allocations, where the PPDUs comprise one or more MSDUs, and wherein the MSDUs from each station are within a scaled limit for MSDUs.

### PRIORITY CLAIM

This application claims the benefit of priority under 35 USC 119(e) to U.S. Provisional Patent Application Ser. No. 62/296,811, filed Feb. 18, 2016, and U.S. Provisional Patent Application Ser. No. 62/318,460, filed Apr. 5, 2016, both of which are incorporated herein by reference in their entirety.

### TECHNICAL FIELD

Embodiments relate to Institute of Electrical and Electronic Engineers (IEEE) 802.11. Some embodiments relate to high-efficiency (HE) wireless local-area networks (WLANs). Some embodiments relate to IEEE 802.11ax. Some embodiments relate computer readable media, methods, and apparatuses for limits on aggregated (A) media access control (MAC) service data units (A-MSDU).

### BACKGROUND

Efficient use of the resources of a wireless local-area network (WLAN) is important to provide bandwidth and acceptable response times to the users of the WLAN. However, often there are many devices trying to share the same resources and the devices may interfere with one another. Additionally, the wireless devices may be moving and the signal quality may be changing. Moreover, wireless devices may need to operate with both newer protocols and with legacy device protocols.

### BRIEF DESCRIPTION OF THE DRAWINGS

The present disclosure is illustrated by way of example and not limitation in the figures of the accompanying drawings, in which like references indicate similar elements and in which:

FIG. 1 illustrates a WLAN in accordance with some embodiments;

FIG. 2 illustrates a frame with A-MSDU subframes in accordance with some embodiments;

FIG. 3 illustrates a frame with A-MPDU subframes in accordance with some embodiments;

FIG. 4 illustrates a transport control protocol (TCP) acknowledgment (ACK) in accordance with some embodiments;

FIG. 5 illustrates portions buffers and an internal bus of a legacy device, HE station and HE access point in accordance with some embodiments;

FIG. 6 illustrates a minimum (min) MSDU spacing field in accordance with some embodiments;

FIG. 7 illustrates a minimum MSDU average spacing field in accordance with some embodiments;

FIG. 8 illustrates a method of limits for A-MSDUs in accordance with some embodiments;

FIG. 9 illustrates a trigger frame (TF) in accordance with some embodiments;

FIG. 10 illustrates a method of limits for A-MSDUs in accordance with some embodiments;

FIG. 11 illustrates a method of limits for A-MSDUs in accordance with some embodiments;

FIG. 12 illustrates a method of limits for A-MSDUs in accordance with some embodiments; and

FIG. 13 illustrates a block diagram of an example machine upon which any one or more of the techniques (e.g., methodologies) discussed herein may perform.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

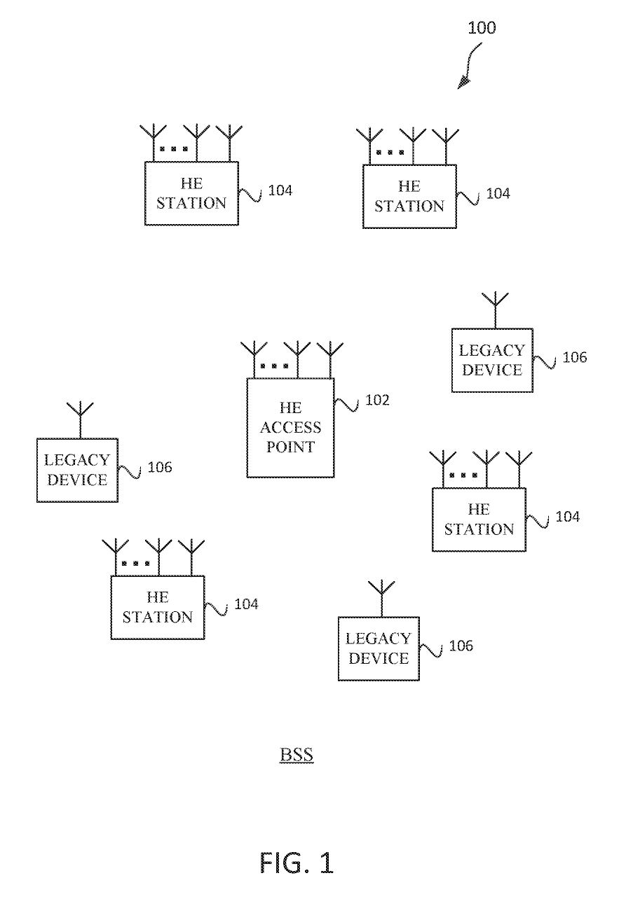

FIG. 1 illustrates a WLAN 100 in accordance with some embodiments. The WLAN 100 may comprise a basis service set (BSS) 100 that may include a HE access point 102, which may be an AP, a plurality of high-efficiency wireless (e.g., IEEE 802.11ax) (HE) stations 104, and a plurality of legacy (e.g., IEEE 802.11n/ac) devices 106.

The HE access point 102 may be an AP using the IEEE 802.11 to transmit and receive. The HE access point 102 may be a base station. The HE access point 102 may use other communications protocols as well as the IEEE 802.11 protocol. The IEEE 802.11 protocol may be IEEE 802.11ax. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO). There may be more than one HE access point 102 that is part of an extended service set (ESS). A controller (not illustrated) may store information that is common to the more than one HE access points 102.

The legacy devices 106 may operate in accordance with one or more of IEEE 802.11 a/b/g/n/ac/ad/af/ah/aj/ay, or another legacy wireless communication standard. The legacy devices 106 may be STAs or IEEE STAs. The HE STAs 104 may be wireless transmit and receive devices such as cellular telephone, portable electronic wireless communication devices, smart telephone, handheld wireless device, wireless glasses, wireless watch, wireless personal device, tablet, or another device that may be transmitting and receiving using the IEEE 802.11 protocol such as IEEE 802.11ax or another wireless protocol. In some embodiments, the HE STAs 104 may be termed high efficiency (HE) stations.

The HE access point 102 may communicate with legacy devices 106 in accordance with legacy IEEE 802.11 communication techniques. In example embodiments, the HE access point 102 may also be configured to communicate with HE STAs 104 in accordance with legacy IEEE 802.11 communication techniques.

In some embodiments, a HE frame may be configurable to have the same bandwidth as a channel. The HE frame may he a physical (PRY) layer convergence procedure (PLCP) protocol data unit (PPDU). In some embodiments, there may be different types of PPDUs that may have different fields and different physical layers and/or different media access control (MAC) layers. In some embodiments, there may be different PPDU formats for different communication standards, e.g., a non-HT PPDU for IEEE 802.11a, HT PPDU for IEEE 802.11n, VHT PPDU for IEEE 802.11ac, or HE PPDU for IEEE 802.11ax.

The bandwidth of a channel may be 20 MHz, 40 MHz, or 80 MHz, 160 MHz, 320 MHz contiguous bandwidths or an 80+80 MHz (160 MHz) non-contiguous bandwidth. In some embodiments, the bandwidth of a channel may be 1 MHz, 1.25 MHz, 2.03 MHz, 2.5 MHz, 4.06 MHz, 5 MHz and 10 MHz, or a combination thereof or another bandwidth that is less or equal to the available bandwidth may also be used. In some embodiments the bandwidth of the channels may be based on a number of active data subcarriers. In some embodiments the bandwidth of the channels is based on 26, 52, 106, 242, 484, 996, or 2×996 active data subcarriers or tones that are spaced by 20 MHz. In some embodiments the bandwidth of the channels is 256 tones spaced by 20 MHz. In some embodiments the channels are multiple of 26 tones or a multiple of 20 MHz. In some embodiments a 20 MHz channel may comprise 242 active data subcarriers or tones, which may determine the size of a Fast Fourier Transform (FFT). An allocation of a bandwidth or a number of tones or sub-carriers may be termed a resource unit (RU) allocation in accordance with some embodiments.

In some embodiments, the 26-subcarrier RU and 52-subcarrier RU are used in the 20 MHz, 40 MHz, 80 MHz, 160 MHz and 80+80 MHz OFDMA HE PPDU formats. In some embodiments, the 106-subcarrier RU is used in the 20 MHz, 40 MHz, 80 MHz, 160 MHz and 80+80 MHz OFDMA and MU-MIMO HE PPDU formats. In some embodiments, the 242-subcarrier RU is used in the 40 MHz, 80 MHz, 160 MHz and 80+80 MHz OFDMA and MU-MIMO HE PPDU formats. In some embodiments, the 484-subcarrier RU is used in the 80 MHz, 160 MHz and 80+80 MHz OFDMA and MU-MEMO HE PPDU formats. In some embodiments, the 996-subcarrier RU is used in the 160 MHz and 80+80 MHz OFDMA and MU-MIMO HE PPDU formats.

A HE frame may be configured for transmitting a number of spatial streams, which may be in accordance with MU-MIMO and may be in accordance with OFDMA. In other embodiments, the HE access point 102, HE STA 104, and/or legacy device 106 may also implement different technologies such as code division multiple access (CDMA) 2000, CDMA 2000 1×, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, or other technologies.

Some embodiments relate to HE communications. In accordance with some IEEE 802.11 embodiments, e.g., IEEE 802.11ax embodiments, a HE access point 102 may operate as a HE access point which may be arranged to contend for a wireless medium (e.g., during a contention period) to receive exclusive control of the medium for an HE control period. In some embodiments, the HE control period may be termed a transmission opportunity (TXOP). The HE access point 102 may transmit a HE master-sync transmission, which may be a trigger frame or HE control and schedule transmission, at the beginning of the HE control period. The HE access point 102 may transmit a time duration of the TXOP and sub-channel information. During the HE control period, HE STAs 104 may communicate with the HE access point 102 in accordance with a non-contention based multiple access technique such as OFDMA or MU-MIMO. This is unlike conventional WLAN communications in which devices communicate in accordance with a contention-based communication technique, rather than a multiple access technique. During the HE control period, the HE access point 102 may communicate with HE stations 104 using one or more HE frames, During the HE control period, the HE STAs 104 may operate on a sub-channel smaller than the operating range of the HE access point 102. During the HE control period, legacy stations refrain from communicating. The legacy stations may need to receive the communication from the HE access point 102 to defer from communicating.

In accordance with some embodiments, during the TXOP the HE STAs 104 may contend for the wireless medium with the legacy devices 106 being excluded from contending for the wireless medium during the master-sync transmission. In some embodiments the trigger frame may indicate an UL-MU-MIMO and/or UL OFDMA TXOP. In some embodiments, the trigger frame may include a DL UL-MU-MIMO and/or DL OFDMA with a schedule indicated in a preamble portion of trigger frame.

In some embodiments, the multiple-access technique used during the HE TXOP may be a scheduled OFDMA technique, although this is not a requirement. In some embodiments, the multiple access technique may be a time-division multiple access (TDMA) technique or a frequency division multiple access (TDMA) technique. In some embodiments, the multiple access technique may be a space-division multiple access (SDMA) technique. In some embodiments, the multiple access technique may be a Code division multiple access (CDMA).

The HE access point 102 may also communicate with legacy stations 106 and/or HE stations 104 in accordance with legacy IEEE 802.11 communication techniques. In some embodiments, the HE access point 102 may also be configurable to communicate with HE stations 104 outside the HE TXOP in accordance with legacy IEEE 802.11 communication techniques, although this is not a requirement.

In some embodiments the HE station 104 may be a “group owner” (GO) for peer-to-peer modes of operation. A wireless device may be a HE station 102 or a HE access point 102.

In some embodiments, the HE station 104 and/or HE access point 102 may be configured to operate in accordance with IEEE 802.11mc. A HE station 104 and/or HE access point 102 may be termed an HE device (e.g., station or AP), if the HE device complies with a wireless communication standard IEEE 802.11ax.

In some embodiments, the HE stations 104 may have limited power. In some embodiments, the HE stations 104 may have limited power and may transmit on an RU less than 20 MHz in order to reach the HE access point 104. In example embodiments, the HE station 104 and/or the HE access point 102 are configured to perform the methods and functions described herein in conjunction with FIGS. 1-13.

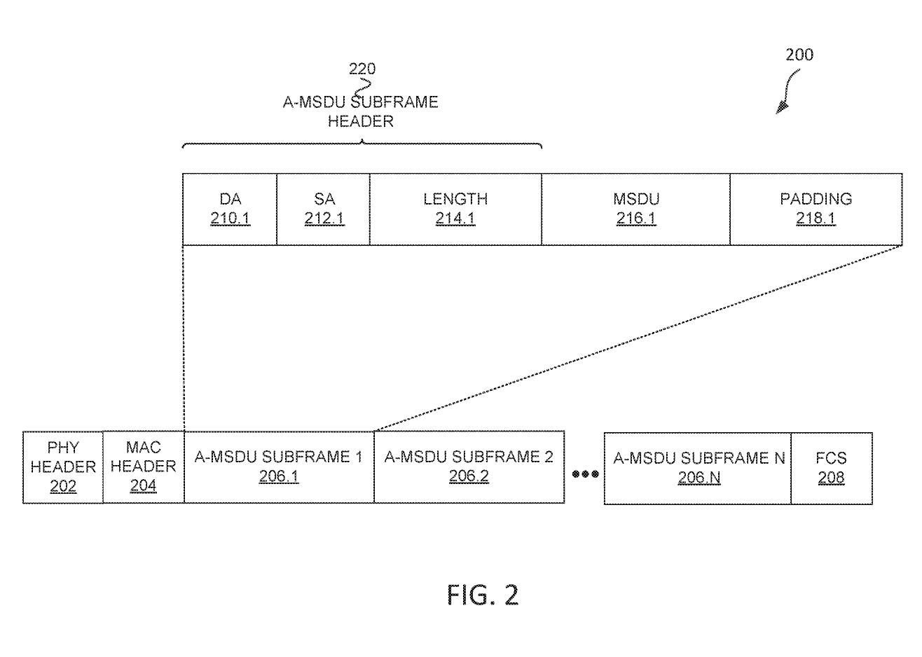

FIG. 2 illustrates a frame 200 with A-MSDU subframes 206 in accordance with some embodiments. Illustrated in FIG. 2 is a frame 200 that include physical (PHY) header 202 field, media access control (MAC) header 204 field, A-MSDU subframe 1 206,1 through A-MSDU subframe N 206.N, and frame check sequence (FCS) 208.

The PHY header 202 may include one or more fields for synchronization, addressing, encoding, transmission, etc. (e.g., short-training field, long-training field, legacy signal field, and one or more HE signal fields). The MAC header 204 may include one or more fields for addressing, length, deferment, encoding, etc. (e.g., destination address, receiver address, network allocation vector length, etc.).

Each A-MSDU subframe 1 206 includes A-MSDU subframe header 220, MSDU 216, and padding 218. The destination address (DA) 210 may be a destination for the A-MSDU subframe 206. The source address (SA) 212 may be a source address of the A-MSDU subframe 206. The length 214 may be a length of the MSDU 216 in octets. The padding 218 may be zero to three octets.

The FCS 208 may provide error detection and correction information. In some embodiments, an A-MSDU subframe header 220 may be different for mesh frames 200. In some embodiments, A-MSDU subframes 206 may have short form that does not include one or more of the fields of A-MSDU subframes 206 as illustrated in FIG. 2. The frame 200 may be a PPDU.

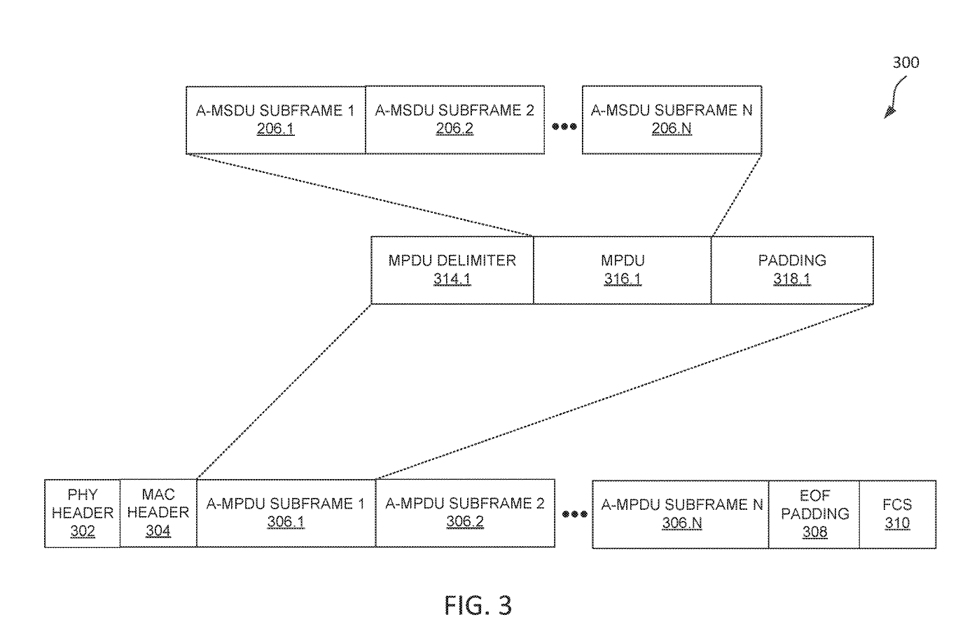

FIG. 3 illustrates a frame 300 with A-MPDU subframes 306 in accordance with some embodiments. The frame 300 may include PHY header 302, MAC header 304, A-MPDU 300 may include A-MPDU subframes 1 306.1 through A-MPDU 306.N, EOF padding 308 field, and FCS 310. The PHY header 302, MAC header 304, and FCS 310 may be the same or similar as the PHY header 202, MAC header 204, and FCS 208, respectively, as described in conjunction with FIG. 2. The EOF padding 308 field may contain EOF padding subframes that are A-MPDUs subframes with zero in the MPDU length field and 1 in the EOF field.

The A-MPDU subframes 306 may include MPDU delimiter 314, MPDU 316, and padding 318. The MPDU delimiter 314.1 may include one or more of the following: an end of frame (EOF) field, MPDU length field, cyclic redundancy check (CRC) field, and delimiter signature field. The MPDU 316.1 may be a MPDU. The padding 318.1 may be zero to three octets. The frame 300 may be a PPDU.

In some embodiments, a MPDU 316 may include one or more A-MSDU subframes 206. In some embodiments, an MPDU 316 may be limited in size, e.g., 11,454 bytes. In some embodiments, a number of A-MSDU subframes 206 that can be included in a MPDU 316 may be limited. In some embodiments, a number of A-MPDU subframes 306 that can be included in frame 300 is limited, e.g., in some embodiments to 64.

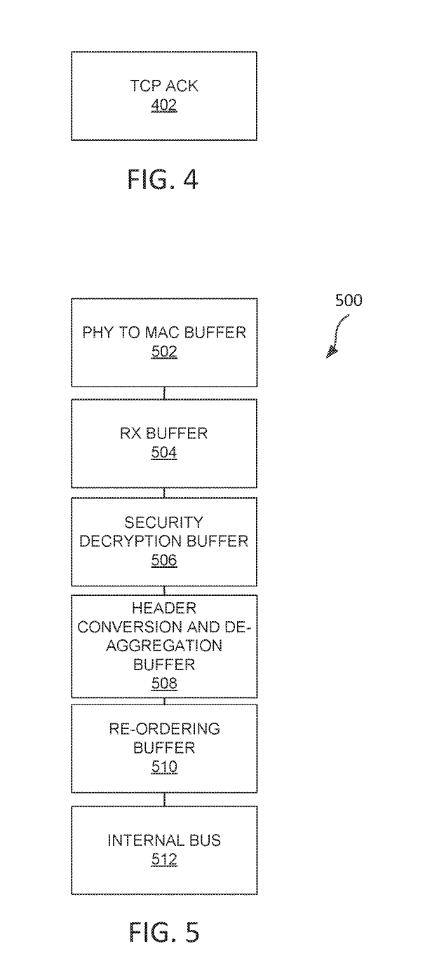

FIG. 4 illustrates a transport control protocol (TCP) acknowledgment (ACK) 402 in accordance with some embodiments. Many of the frames that are transmitted between the HE access point 102 and the legacy devices 106 and/or HE stations 104 contain TCP packets. A TCP packet needs to be ACK'ed in the reverse direction, by a packet such as the TCP ACK 402. The TCP ACK 402 is approximately 64 bytes in accordance with some embodiments. A legacy device 106, HE station 104, and/or HE access point 102 may be limited in a number of MSDUs 216 that the device can process. In some embodiments, a number of MSDUs 216 in a frame 300 may be large. For example, if a MPDU 316 is limited by 11,454 bytes and an MSDU 216 is 1,500 bytes, and a number of A-MPDU subframes 306 is limited to 64, then a frame 300 may include 448 MSDUs 216. In some embodiments, the MSDUs 216 may be smaller for more MSDUs 216 in a single frame 300.

FIG. 5 illustrates portions buffers and an internal bus 512 of a legacy device 106, HE station 104 and HE access point 102 in accordance with some embodiments. Illustrated in FIG. 5 is physical (PHY) to media access control (MAC) buffer 502, receive (RX) buffer 504, security decryption buffer 506, header conversion and de-aggregation buffer 508, and internal bus 512. A legacy device 106, HE station 104, and/or HE access point 102 may be overloaded when receiving TCP ACKs 402 which may be a large number from MSDUs 216 being aggregated with TCP ACKs 402 and MPDUs 316 being aggregated with A-MSDU subframes 206. In some embodiments, the legacy device 106, HE station 104, and/or HE access point 102 may be overloaded from a large number of MSDUs 216. Frame 300 may enable a large number of MSDUs 216 to be transmitted in a single frame 300.

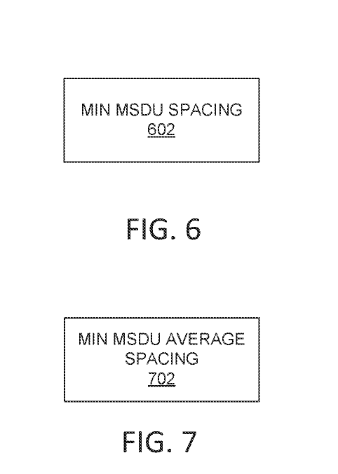

FIG. 6 illustrates a minimum (min) MSDU spacing 602 field in accordance with some embodiments. The min MSDU spacing 602 field may provide a way for a HE station 104, legacy device 106, and/or HE access point 102 to indicate their receiver MSDU aggregation processing capability limits. In some embodiments, the min MSDU spacing 602 field may be used to agree on a maximum aggregated MSDU transmission ratio for the HE station 104, legacy device 106, and/or HE access point 102 to transmit to another device.

In some embodiments, the min MSDU spacing 602 field may be maximum MSDU 216 transmissions ratio or receiver MSDU aggregation processing capability limits. In some embodiments, the min MSDU spacing 602 field may be a minimum MSDU 216 start spacing. The minimum MSDU 216 start spacing may be a minimum time between the start of adjacent MSDUs 216 within an A-MSDU 206 that the legacy device 106, HE station 104 and/or HE access point 102 can receive. In some embodiments, the minimum time between the start of adjacent MSDUs 216 within an A-MSDU 206 may be measured at a PHY-service access point (SAP).

In some embodiments, the min MSDU spacing 602 field may be part of a capabilities element. In some embodiments, the min MSDU spacing 602 field may be part of a capabilities information element of a legacy device 106, HE station 104 and/or HE access point 102. For a legacy device 106 the min MSDU spacing 602 field may be one or more reserved bits of a legacy communication standard. In some embodiments, the min MSDU spacing 602 field may be part of field of a frame, or part of an information element.

In some embodiments, the min MSDU spacing 602 may have one or more of the values indicated in Table 1. A different number of values may be used and the meaning of the values may be different, in accordance with some embodiments. In some embodiments, the meaning may be in a number of bytes between MSDUs. In some embodiments, the min MSDU spacing 602 field may be termed a min MSDU start spacing 602 field, which may indicate a minimum time or number of bytes before a next MSDU 216 may begin.

TABLE 1
Value of Min MSDU Spacing

| Value | Meaning | |
|---|---|---|
| 0 | No restriction | |
| 1 | ¼ | μs |
| 2 | ½ | μs |
| 3 | 1 | μs |
| 4 | 2 | μs |
| 5 | 5 | μs |
| 6 | 8 | μs |
| 7 | 16 | μs |

FIG. 7 illustrates a minimum MSDU average spacing 702 field in accordance with some embodiments. In some embodiments, the minimum MSDU average spacing 702 field may indicate an average minimum spacing for MSDUs 216 that the receiver (e.g., legacy device 106, HE station 104, HE access point 102) needs for the receiver to be able to process the MSDUs 216. The min MSDU average spacing 702 may be an average MSDU spacing which defines the average time between MSDU start and transmission times.

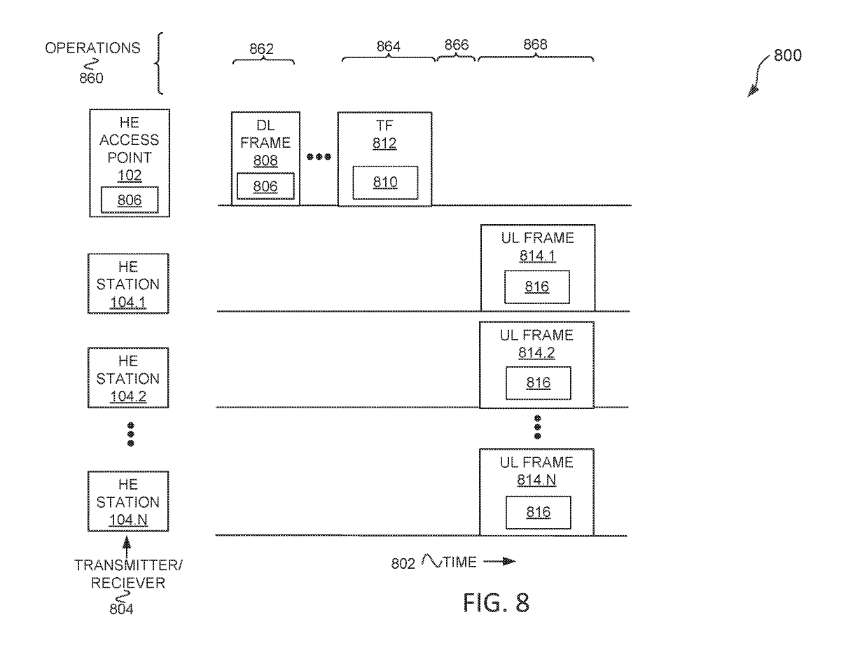

FIG. 8 illustrates a method 800 of limits for A-MSDUs in accordance with some embodiments. Illustrated in FIG. 8 is time 802 along a horizontal axis, transmitter/receiver 804 along a vertical axis, and operations 860 along the top.

The method 800 begins at operation 862 with the HE access point 102 transmitting a DL frame 808. The DL frame 808 may include a limit for A-MSDUs 806. The limit for A-MSDUs 806 may be a minimum MSDU average spacing 702 or minimum MSDU spacing 602 as disclosed in conjunction with FIGS. 6 and 7, respectively.

The limit for A-MSDUs 806 may indicate a limit on how frequently MSDUs 216 can be sent to the HE access point 102, which may be based on the HE access point 102 processing ability. The DL frame 808 may be single user PPDU. The DL frame 808 may be a beacon frame. The limit for A-MSDU 806 may be part of a capabilities information element. The HE stations 104 may be configured to store the limit for A-MSDU 806. In some embodiments, operation 862 may be multiple transmissions from the HE access point 102 to one or more HE stations 104. The HE stations 104 may be associated with the HE access point 102 and receive the limit for A-MSDU 806 as part of the association process. In some embodiments, the limit for A-MSDUs 806 is included in the TF 812.

The method 800 may continue at operation 864 with the HE access point 102 transmitting a trigger frame (TF) to the HE stations 104. The TF 812 may include UL resource allocations 810 for the HE stations 104. The UT resource allocations 810 may include a common portion and per user (station) portion.

The method 800 continues at operation 866 with the HE stations 104 waiting a duration, e.g., short inter-frame space (SIFS).

The method 800 continues at operation 868 with the HE stations 104 transmitting UL frames 814 in accordance with the UL resource allocations 810 and the limit for A-MSDU 816. In some embodiments, the HE stations 104 are configured to determine a number N of the HE stations 104 that are given UL resource allocation 810 and divide limit for A-MSDU 806 by N to derive a limit for A-MSDU 816 for their UL frames 814.

In some embodiments, the limit for A-MSDU 806 is a min MSDU average spacing 702. And, the HE stations 104 divide the min MSDU average spacing 702 by the number N of HE stations 104 that are given UL resource allocation 810 to derive the limit for A-MSDU 816.

In some embodiments, the limit for A-MSDU 806 is a min MSDU spacing 602. And, the HE stations 104 divide the min MSDU spacing 602 by the number N of HE stations 104 that are given UL resource allocation 810 to derive the limit for A-MSDU 816. In some embodiments, the HE stations 104 determine a factor based on a proportion of the bandwidth in the UL resource allocation 810 and multiple the limit for A-MSDU 806 by the factor to derive a limit for A-MSDU 816 (e.g., min MSDU spacing 602 or min MSDU average spacing 702) for their UL frames 814. For example, the UL resource allocation 810 may be 80 MHz and the HE station 04 may receive 5 MHz of the bandwidth. The factor is then 5/80 or 1/16 of the limit for A-MSDU 816. In some embodiments, the HE stations 104 would look at the MCS that each HE station 104 is assigned and the bandwidth to determine a factor for their portion of the limit for A-MSDU 816. In some embodiments, determining the factor and multiplying the limit for A-MSDU 806 by the factor to determine the limit for A-MSDU 816 may be termed scaling the limit for A-MSDU 806.

The UL frames 814 may be frames 200 or 300. The frames 814 may include one or more MSDUs 216 and one or more A-MSDUs. The HE stations 104 are configured to transmit the frames 814 to the HE access point 102 within the limit for A-MSDU 806.

The RE stations 104 and/or HE access point 102 may be configured to transmit SU frames to one another in accordance with the limit for A-MSDU 806. In the SU case the HE stations 104 do not adjust the limit for A-MSDU 806 by a factor, in accordance with some embodiments. In some embodiments, the HE stations 104 adjust the limit for A-MSDU 806 by factor based on a number of HE stations 104 associated with the HE access point 102.

In some embodiments, the HE stations 104 transmit a limit for A-MSDU 816 to the HE access point 102 during association with the HE access point 102 or in another transmission and the HE access point 102 is configured to limit MSDUs 216 to the HE stations 104 in accordance with the limit for A-MSDU 816.

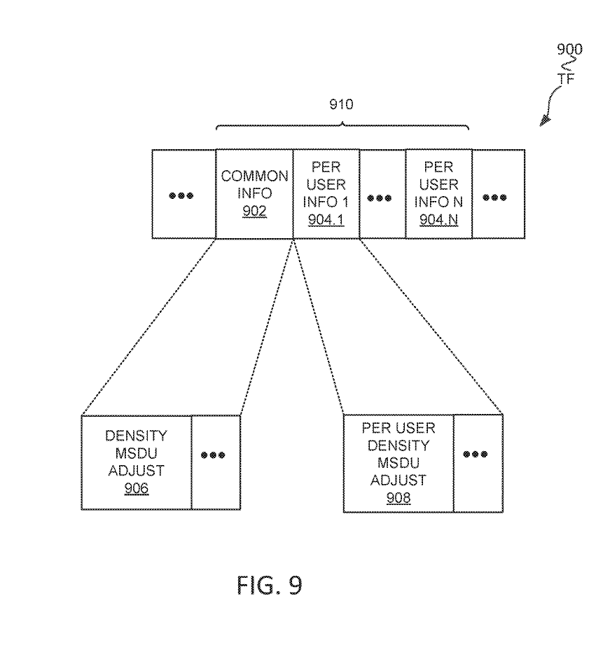

FIG. 9 illustrates a trigger frame (TF) 900 in accordance with some embodiments. The TF 900 includes a UL resource allocation 910. The UL resource allocation 910 includes common information 902 and per user information 1 904.1 through per user information N 904.N. The common information 902 may include density MSDU adjust 906 in accordance with some embodiments. The density MSDU adjust 906 may be used to adjust the minimum MSDU spacing 602 and/or minimum MSDU average spacing 702. The density MSDU adjust 906 may be common for each of the HE stations 104 to use. The per user information 904 may include per user density MSDU adjust 908. The per user density MSDU adjust 908 may be just for the corresponding HE station 104 to use to adjust the minimum MSDU spacing 602 and/or minimum MSDU average spacing 702. In some embodiments, the TF 910 includes only one of the density MSDU adjust 906 or per user density MSDU adjust 908. In some embodiments, the density MSDU adjust 906 or per user density MSDU adjust 908 field may have an encoding to indicate how to adjust the minimum MSDU spacing 602 and/or minimum MSDU average spacing 702. For example, the field may be 3 bits and a value 010 may indicate divide the minimum MSDU spacing 602 and/or minimum MSDU average spacing 702 by one-half.

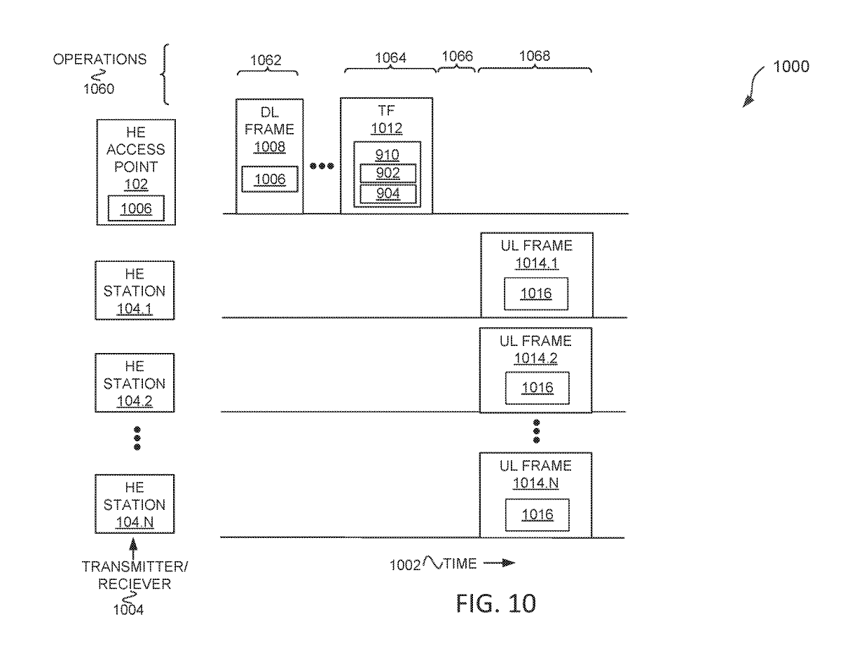

FIG. 10 illustrates a method 1000 of limits for A-MSDUs in accordance with some embodiments. Illustrated in FIG. 10 is time 1002 along a horizontal axis, transmitter/receiver 1004 along a vertical axis, and operations 1060 along the top.

The method 1000 begins at operation 1062 with the HE access point 102 transmitting a DL frame 1008. The DL frame 1008 may include a limit for A-MSDUs 1006. The limit for A-MSDUs 1006 may be a minimum MSDU average spacing 702 or minimum MSDU spacing 602 as disclosed in conjunction with FIGS. 6 and 7, respectively.

The limit for A-MSDUs 1006 may indicate a limit on how frequently MSDUs 216 can be sent to the HE access point 102, which may be based on the HE access point 102 processing ability. The DL frame 1008 may be single user PPDU. The DL frame 1008 may be a beacon frame. The limit for A-MSDU 1006 may be part of a capabilities information element. The HE stations 104 may be configured to store the limit for A-MSDU 1006. In some embodiments, operation 1062 may be multiple transmissions from the HE access point 102 to one or more HE stations 104. The HE stations 104 may be associated with the HE access point 102 and receive the limit for A-MSDU 1006 as part of the association process. In some embodiments, the limit for A-MSDUs 1006 is included in the TF 1012.

The method 1000 may continue at operation 1064 with the HE access point 102 transmitting a TF 1012 to the HE stations 104. The TF 1012 may include UL resource allocations 910 (FIG. 9) for the HE stations 104. The UL resource allocations 910 may include a common information 902 and per user (station) information 904.

The method 800 continues at operation 1066 with the HE stations 104 waiting a duration, e.g., short inter-frame space (SIFS).

The method 1000 continues at operation 1068 with the HE stations 104 transmitting UL, frames 1014 in accordance with the UL resource allocations 1010 and the limit for A-MSDU 1016.

In some embodiments, the HE stations 104 are configured to determine the limit for A-MSDUs 1016 in accordance with the limit for A-MSDUs 1006 and the density MSDU adjust 906. For example, the HE stations 104 may multiply (or divide) limit for A-MSDU 1006 by a value indicated by density MSDU adjust 906 to determine limit for A-MSDU 1016. The density MSDU adjust 906 may indicate a scaling factor.

In some embodiments, the HE stations 104 are configured to determine the limit for A-MSDUs 1016 in accordance with the limit for A-MSDUs 1006 and the per user density MSDU adjust 908. For example, the HE stations 104 may multiply (or divide) limit for A-MSDU 1006 by a value indicated by per user density MSDU adjust 908 to determine limit for A-MSDUs 1016. The per user density MSDU adjust 908 may indicate a scaling factor.

The UL frames 1014 may be frames 200 or 300. The UL frames 1014 may include one or more MSDUs 216 and one or more A-MSDUs. The HE stations 104 are configured to transmit the UL frames 1014 to the HE access point 102 within the limit for A-MSDU 1016.

A minimum MSDU average spacing 702 may provide more flexibility in the aggregation of small MSDU (e.g., TCP ACKs 402) while preserving a high likelihood that buffers (FIG. 5) and/or internal buses 512 will not be overflowed. In some embodiments, there is not A-MSDU subframe 206 padding, e.g., there is not padding 218.1, or padding 218.1 does not provide sufficient padding. That means that using a hard limit of minimum MSDU spacing 602, which may define the exact time between two consecutive A-MSDUs 206 (or MSDU 216) may not flexible enough. For example, assuming a HE station 104 and/or HE access point 102 has to transmit 10 MSDUs of 64B (e.g., TCP ACK 402), and the MSDU density limitation is minimum MSDU spacing 602, and is equivalent to 128 B, then the HE station 104 and/or HE access point 102 would have to transmit 10 MPDUs that contain single MSDU to stay within the minimum MSDU spacing 602. By using minimum MSDU average spacing 702 (e.g., equivalent to 128B) for A-MSDUs 806, 816, 1006, 1016 instead of minimum MSDU spacing 602, the HE stations 104 and/or HE access point 102 are able to transmit 5 MPDUs 316.1 (FIG. 3) with every MPDU 316.1 containing two MSDUs 216.1 (e.g., A-MSDU subframe 206.1 and 206.2). The padding 318.1 may be used to achieve the necessary minimum MSDU average spacing 702, if necessary.

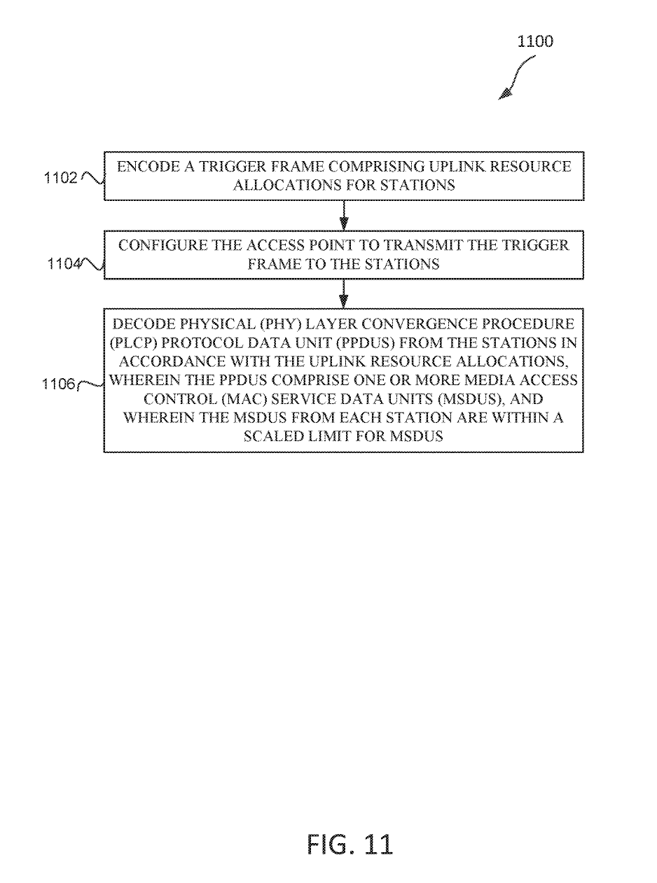

FIG. 11 illustrates a method 1100 of limits for A-MSDUs in accordance with some embodiments. The method 1100 begins at operation 1102 with encoding a trigger frame comprising uplink resource allocations for stations. For example, an apparatus of HE access point 102 may encode TF 812 as described in conjunction with FIG. 8. In another example, an apparatus of HE access point 102 may encode TF 1012 as described in conjunction with FIG. 10.

The method 1100 continues at operation 1104 with configuring the access point to transmit the trigger frame to the stations. For example, an apparatus of the HE access point 102 of FIG. 8 or FIG. 10 may configure the HE access point 102 to transmit TF 812 or TF 1012, respectively.

The method 1100 continues at operation 1106 with decoding PPDUs from the stations in accordance with the uplink resource allocations, where the PPDUs comprise one or more MSDUs, and where the MSDUs from each station are within a scaled limit for MSDUs. For example, HE access point 102 may decode UL frames 814 that are within limit for A-MSDUs 816 as described in conjunction with FIG. 8. In another example, HE access point 102 may decode UL frames 1014 that are within limit for A-MSDUs 1016 as described in conjunction with FIG. 10. One or more of the operations above may be performed by an apparatus of the HE access point 102.

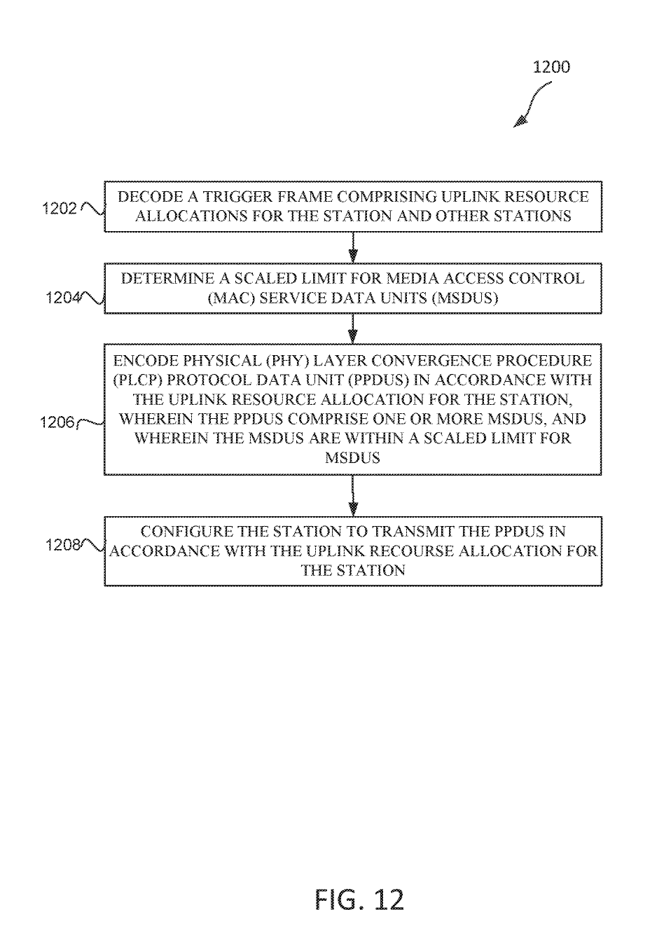

FIG. 12 illustrates a method 1200 of limits for A-MSDUs in accordance with some embodiments. The method 1200 may begin with operation 1202 with decoding a trigger frame comprising uplink resource allocations for the station and other stations. For example, HE stations 104 may decode TF 812 including uplink resource allocation 810 as disclosed in conjunction with FIG. 8. In another example, HE stations 104 may decode TF 1012 including uplink resource allocation 1012 as disclosed in conjunction with FIG. 12.

The method 1200 may continue at operation 1204 with determining a scaled limit for MSDUs. For example, HE stations 104 may determine limit for A-MSDU 816 as disclosed in conjunction with FIG. 8. In another example, HE stations 104 may determine limit for A-MSDU 1016 as disclosed in conjunction with FIG. 12.

The method 1200 may continue at operation 1206 with encoding PPDUs in accordance with the uplink resource allocation for the station, where the PPDUs comprise one or more MSDUs, and where the MSDUs are within a scaled limit for MSDUs. For example, HE stations 104 may encode UL frames 814 in accordance with the A-MSDU 816 and the uplink resource allocation 810 as disclosed in conjunction with FIG. 8. In another example, HE stations 104 may encode UL frames 1014 in accordance with limit for A-MSDU 1016 and uplink resource allocation 1012 as disclosed in conjunction with FIG. 12.

In some embodiments, operation 1206 comprises encoding PPDUs in accordance with the uplink resource allocation for the station, where the PPDUs comprise one or more MSDUs, and where the MSDUs are within a scaled limit for MSDUs, and wherein the scaled limit for MSDUs is based on the number of stations.

The method 1200 may continue at operation 1208 with configuring the station to transmit the PPDUs in accordance with the uplink recourse allocation for the station. For example, an apparatus of HE stations 104 may configure the HE stations 104 to transmit frames 814 as disclosed in conjunction with FIG. 8. In another example, an apparatus of HE stations 104 may configure the HE stations 104 to transmit UL frames 1014 as disclosed in conjunction with FIG. 10. An apparatus of a HE station 104 may perform or configure the HE station 104 to perform one more of the operations above.

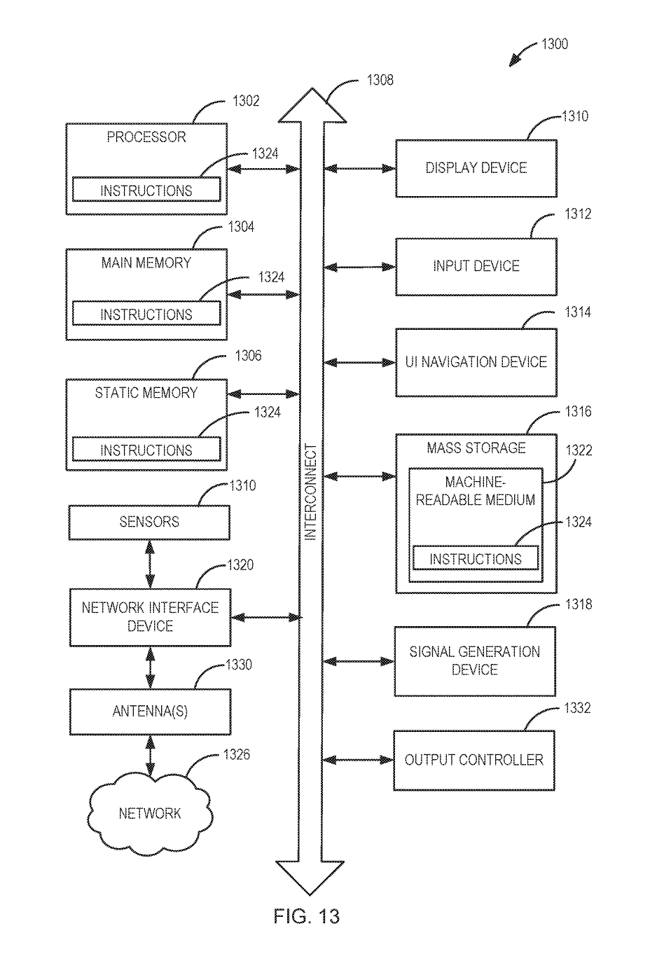

FIG. 13 illustrates a block diagram of an example machine 1300 upon which any one or more of the techniques (e.g., methodologies) discussed herein may perform. In alternative embodiments, the machine 1300 may operate as a standalone device or may be connected (e.g., networked) to other machines. In a networked deployment, the machine 1300 may operate in the capacity of a server machine, a client machine, or both in server-client network environments. In an example, the machine 1300 may act as a peer machine in peer-to-peer (P2P) (or other distributed) network environment. The machine 1300 may be a HE access point 102, HE station 104, personal computer (PC), a tablet PC, a set-top box (STB), a personal digital assistant (PDA), a portable communications device, a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Machine (e.g., computer system) 1300 may include a hardware processor 1302 (e.g., a central processing unit (CPU), a graphics processing unit (GPU), a hardware processor core, or any combination thereof), a main memory 1304 and a static memory 1306, some or all of which may communicate with each other via an interlink (e.g., bus) 1308.

Specific examples of main memory 1304 include Random Access Memory (RAM), and semiconductor memory devices, which may include, in some embodiments, storage locations in semiconductors such as registers. Specific examples of static memory 1306 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

The machine 1300 may further include a display device 1310, an input device 1312 (e.g., a keyboard), and a user interface (UI) navigation device 1314 (e.g., a mouse). In an example, the display device 1310, input device 1312 and UI navigation device 1314 may be a touch screen display. The machine 1300 may additionally include a mass storage (e.g., drive unit) 1316, a signal generation device 1318 (e.g., a speaker), a network interface device 1320, and one or more sensors 1321, such as a global positioning system (GPS) sensor, compass, accelerometer, or other sensor. The machine 1300 may include an output controller 1328, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments the processor 1302 and/or instructions 1324 may comprise processing circuitry and/or transceiver circuitry.

The storage device 1316 may include a machine readable medium 1322 on which is stored one or more sets of data structures or instructions 1324 (e.g., software) embodying or utilized by any one or more of the techniques or functions described herein. The instructions 1324 may also reside, completely or at least partially, within the main memory 1304, within static memory 1306, or within the hardware processor 1302 during execution thereof by the machine 1300. In an example, one or any combination of the hardware processor 1302, the main memory 1304, the static memory 1306, or the storage device 1316 may constitute machine readable media.

Specific examples of machine readable media may include: non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

While the machine readable medium 1322 is illustrated as a single medium, the term “machine readable medium” may include a single medium or multiple media (e.g., a centralized or distributed database, and/or associated caches and servers) configured to store the one or more instructions 1324.

An apparatus of the machine 1300 may be one or more of a hardware processor 1302 (e.g., a central processing unit (CPU), a graphics processing unit (GPU), a hardware processor core, or any combination thereof), a main memory 1304 and a static memory 1306, sensors 1321, network interface device 1320, antennas 1360, a display device 1310, an input device 1312, a UI navigation device 1314, a mass storage 1316, instructions 1324, a signal generation device 1318, and an output controller 1328. The apparatus may be configured to perform one or more of the methods and/or operations disclosed herein. The apparatus may be intended as a component of the machine 1300 to perform one or more of the methods and/or operations disclosed herein, and/or to perform a portion of one or more of the methods and/or operations disclosed herein. In some embodiments, the apparatus may include a pin or other means to receive power. In some embodiments, the apparatus may include power conditioning hardware.

The term “machine readable medium” may include any medium that is capable of storing, encoding, or carrying instructions for execution by the machine 1300 and that cause the machine 1300 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 132.4 may further be transmitted or received over a communications network 1326 using a transmission medium via the network interface device 1320 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others.

In an example, the network interface device 1320 may include one or more physical jacks (e.g., Ethernet, coaxial, or phone jacks) or one or more antennas to connect to the communications network 1326. In an example, the network interface device 1320 may include one or more antennas 1360 to wirelessly communicate using at least one of single-input multiple-output (SIMO), multiple-input multiple-output (MIMO), or multiple-input single-output (MISO) techniques. In some examples, the network interface device 1320 may wirelessly communicate using Multiple User MIMO techniques. The term “transmission medium” shall be taken to include any intangible medium that is capable of storing, encoding or carrying instructions for execution by the machine 1300, and includes digital or analog communications signals or other intangible medium to facilitate communication of such software.

Examples, as described herein, may include, or may operate on, logic or a number of components, modules, or mechanisms. Modules are tangible entities (e.g., hardware) capable of performing specified operations and may he configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; flash memory, etc.

The following examples pertain to further embodiments. Example 1 is an apparatus of an access point, the apparatus including: memory; and processing circuitry coupled to the memory, where the processing circuitry is configured to: encode a trigger frame including uplink resource allocations for stations; configure the access point to transmit the trigger frame to the stations; and decode physical (PHY) layer convergence procedure (PLCP) protocol data unit (PPDUs) from the stations in accordance with the uplink resource allocations, where the PPDUs comprise one or more media access control (MAC) service data units (MSDUs), and where the MSDUs from each station are within a scaled limit for MSDUs, where the scaled limit for MSDUs is to be determined based on a number of the stations.

In Example 2, the subject matter of Example 1 optionally includes where the processing circuitry is further configured to: encode a frame including an access point limit for MSDUs; and configure the access point to transmit the frame to one or more of the stations, where the scaled limit for MSDUs is to be determined further based on the access point limit for MSDUs.

In Example 3, the subject matter of Example 2 optionally includes where the access point limit for MSDUs is a minimum MSDU spacing or a minimum average MSDU spacing.

In Example 4, the subject matter of any one or more of Examples 1-3 optionally include where the scaled limit for MSDUs is determined based on dividing the access point limit for MSDUs by the number of stations indicated in the trigger frame.

In Example 5, the subject matter of any one or more of Examples 1-4 optionally include where the processing circuitry is further configured to: determine a density MSDU adjustment based on the number of the stations.

In Example 6, the subject matter of any one or more of Examples 1-5 optionally include where the trigger frame comprises a common information portion of the uplink resource allocation and the common information portion comprises the density MSDU adjustment, and where the scaled limit for MSDUs is determined based on an access point limit for MSDUs and the density MSDU adjustment.

in Example 7, the subject matter of any one or more of Examples 1-6 optionally include where the scaled limit for MSDUs is a number of bytes or a time duration.

In Example 8, the subject matter of any one or more of Examples 1-7 optionally include where the processing circuitry is further configured to: determine a per station density MSDU adjustment based on the number of stations, and where the trigger frame comprises a per user portion of the uplink resource allocation for each station and each per station portion comprises the per station density MSDU adjustment, and where the scaled limit for MSDUs is to be determined by each station based on an access point limit for MSDUs and a corresponding scaled limit for MSDUs.

In Example 9, the subject matter of any one or more of Examples 1-8 optionally include where the scaled limit for MSDUs is a minimum MSDU spacing or a minimum average MSDU spacing.

In Example 10, the subject matter of any one or more of Examples 1-9 optionally include where one or more of the PPDUs are aggregated PPDUs, and where one or more of the PPDUs comprise aggregated MSDUs.

In Example 11, the subject matter of any one or more of Examples 1-10 optionally include where the processing circuitry is further configured to: encode acknowledgements or block acknowledgements for the PPDUs received from the stations; and configure the access point to transmit the acknowledgements or block acknowledgments to the stations.

In Example 12, the subject matter of any one or more of Examples 1-11 optionally include ax station.

In Example 13, the subject matter of any one or more of Examples 1-12 optionally include transceiver circuitry coupled to the memory; and, one or more antennas coupled to the transceiver circuitry.

Example 14 is a non-transitory computer-readable storage medium that stores instructions for execution by one or more processors, the instructions to configure the one or more processors to cause an apparatus of an access point to: encode a physical (PHY) layer convergence procedure (PLCP) protocol data unit (PPDU) for a second access point or a second station, where the PPDU are within a scaled limit for media access control (MAC) service data units (MSDUs) of the second access point or the second station; and configure the first access point or first station to transmit the PPDU.

In Example 15, the subject matter of Example 14 optionally includes where the instructions further configure the one or more processors to cause the apparatus of the access point to: decode a packet including the scaled limit for MSDUs of the second access point or the second station, where the packet is from the second access point or the second station.

In Example 16, the subject matter of any one or more of Examples 14-15 optionally include where the scaled limit for MSDUs of the second access point is a minimum MSDU spacing or a minimum average MSDU spacing.

In Example 17, the subject matter of any one or more of Examples 14-16 optionally include where the scaled limit for MSDUs is to be determined further based on a portion of a bandwidth indicated in the uplink resource allocation for a station of the stations relative to a total bandwidth for the uplink resource allocation.

in Example 18, the subject matter of any one or more of Examples 14-17 optionally include where one or more of the PPDUs are aggregated PPDUs, and where one or more of the PPDUs comprise aggregated MSDUs.

Example 19 is a method performed by an apparatus of an access point, the method including: encoding a trigger frame including uplink resource allocations for stations; configuring the access point to transmit the trigger frame to the stations; and decoding physical (PHY) layer convergence procedure (PLCP) protocol data unit (PPDUs) from the stations in accordance with the uplink resource allocations, where the PPDUs comprise one or more media access control (MAC) service data units (MSDUs), and where the PPDUs from each station are within a scaled limit for MSDUs.

in Example 20, the subject matter of Example 19 optionally includes where the scaled limit for MSDUs is a minimum MSDU spacing or a minimum average MSDU spacing.

Example 21 is an apparatus of a station, the apparatus including: a memory; and processing circuitry coupled to the memory, where the processing circuitry is configured to: decode a trigger frame including uplink resource allocations for the station; determine a scaled limit for media access control (MAC) service data units (MSDUs); encode physical (PHY) layer convergence procedure (PLCP) protocol data unit (PPDUs) in accordance with the uplink resource allocation for the station, where the PPDUs comprise one or more MSDUs, and where the MSDUs are within the scaled limit for MSDUs; and configure the station to transmit the PPDUs in accordance with the uplink recourse allocation for the station.

In Example, the subject matter of Example 21 optionally includes where the scaled limit for MSDUs is a minimum MSDU spacing or a minimum average MSDU spacing.

in Example 23, the subject matter of any one or more of Examples 21-22 optionally include where the processing circuitry is further configured to: determine the scaled limit for MSDUs based on one from the following group: a number of stations indicated in the uplink resource allocation, a per station density MSDU adjustment included in the trigger frame, or a common density MSDU adjustment included in the trigger frame.

In Example 24, the subject matter of any one or more of Examples 21-23 optionally include ax station.

In Example 25, the subject matter of any one or more of Examples 21-24 optionally include transceiver circuitry coupled to the memory; and, one or more antennas coupled to the transceiver circuitry.

Example 26 is an apparatus of an access point, the apparatus including: means for encoding a trigger frame including uplink resource allocations for stations; means for configuring the access point to transmit the trigger frame to the stations; and means for decoding physical (PHY) layer convergence procedure (PLCP) protocol data unit (PPDUs) from the stations in accordance with the uplink resource allocations, where the PPDUs comprise one or more media access control (MAC) service data units (MSDUs), and where the MSDUs from each station are within a scaled limit for MSDUs, where the scaled limit for MSDUs is to be determined based on a number of the stations.

In Example 27, the subject matter of Example 26 optionally includes means for encoding a frame including an access point limit for MSDUs; and means for configuring the access point to transmit the frame to one or more of the stations, where the scaled limit for MSDUs is to be determined further based on the access point limit for MSDUs.

In Example 28, the subject matter of Example 27 optionally includes where the access point limit for MSDUs is a minimum MSDU spacing or a minimum average MSDU spacing.

In Example 29, the subject matter of any one or more of Examples 26-28 optionally include where the scaled limit for MSDUs is determined based on dividing the access point limit for MSDUs by the number of stations indicated in the trigger frame.

in Example 30, the subject matter of any one or more of Examples 26-29 optionally include means for determining a density MSDU adjustment based on the number of the stations.

In Example 31, the subject matter of any one or more of Examples 26-30 optionally include where the trigger frame comprises a common information portion of the uplink resource allocation and the common information portion comprises the density MSDU adjustment, and where the scaled limit for MSDUs is determined based on an access point limit for MSDUs and the density MSDU adjustment.

in Example 32, the subject matter of any one or more of Examples 26-31 optionally include where the scaled limit for MSDUs is a number of bytes or a time duration.

In Example 33, the subject matter of any one or more of Examples 26-32 optionally include means for determining a per station density MSDU adjustment based on the number of stations, and where the trigger frame comprises a per user portion of the uplink resource allocation for each station and each per station portion comprises the per station density MSDU adjustment, and where the scaled limit for MSDUs is to be determined by each station based on an access point limit for MSDUs and a corresponding scaled limit for MSDUs.

In Example 34, the subject matter of any one or more of Examples 26-33 optionally include where the scaled limit for MSDUs is a minimum MSDU spacing or a minimum average MSDU spacing.

In Example 35, the subject matter of any one or more of Examples 26-34 optionally include where one or more of the PPDUs are aggregated PPDUs, and where one or more of the PPDUs comprise aggregated MSDUs.

In Example 36, the subject matter of any one or more of Examples 26-35 optionally include means for encoding acknowledgements or block acknowledgements for the PPDUs received from the stations; and means for configuring the access point to transmit the acknowledgements or block acknowledgments to the stations.

In Example 37, the subject matter of any one or more of Examples 26-36 optionally include ax station.

In Example 38, the subject matter of any one or more of Examples 26-37 optionally include means for processing radio frequency signals coupled to means for storing and retrieving data; and, means for receiving and transmitting the radio frequency signals.

Example 39 is a non-transitory computer-readable storage medium that stores instructions for execution by one or more processors, the instructions to configure the one or more processors to cause an apparatus of a station to: decode a trigger frame including uplink resource allocations for the station; determine a scaled limit for media access control (MAC) service data units (MSDUs); encode physical (PHY) layer convergence procedure (PUT) protocol data unit (PPDUs) in accordance with the uplink resource allocation for the station, where the PPDUs comprise one or more MSDUs, and where the MSDUs are within the scaled limit for MSDUs; and configure the station to transmit the PPDUs in accordance with the uplink recourse allocation for the station.

In Example 40, the subject matter of Example 39 optionally includes where the scaled limit for MSDUs is a minimum MSDU spacing or a minimum average MSDU spacing.

In Example 41, the subject matter of any one or more of Examples 39-40 optionally include where the instructions further configure the one or more processors to cause the apparatus of the station to: determine the scaled limit for MSDUs based on one from the following group: a number of stations indicated in the uplink resource allocation, a per station density MSDU adjustment included in the trigger frame, or a common density MSDU adjustment included in the trigger frame.

In Example 42, the subject matter of any one or more of Examples 39-41 optionally include ax station.

Example 43 is a method performed by an apparatus of a station, the method including: decode a trigger frame including uplink resource allocations for the station; determine a scaled limit for media access control (MAC) service data units (MSDUs); encode physical (PHY) layer convergence procedure (PLCP) protocol data unit (PPDUs) in accordance with the uplink resource allocation for the station, where the PPDUs comprise one or more MSDUs, and where the MSDUs are within the scaled limit for MSDUs; and configure the station to transmit the PPDUs in accordance with the uplink recourse allocation for the station.

In Example 44, the subject matter of Example 43 optionally includes where the scaled limit for MSDUs is a minimum MSDU spacing or a minimum average MSDU spacing.

In Example 45, the subject matter of any one or more of Examples 43-44 optionally include the method further including: determining the scaled limit for MSDUs based on one from the following group: a number of stations indicated in the uplink resource allocation, a per station density MSDU adjustment included in the trigger frame, or a common density MSDU adjustment included in the trigger frame.

In Example 46, the subject matter of any one or more of Examples 43-45 optionally include ax station.

Example 47 is an apparatus of a station, the apparatus including: means for decoding a trigger frame including uplink resource allocations for the station; means for determining a scaled limit for media access control (MAC) service data units (MSDUs); means for encoding physical (PHY) layer convergence procedure (PLCP) protocol data unit (PPDUs) in accordance with the uplink resource allocation for the station, where the PPDUs comprise one or more MSDUs, and where the MSDUs are within the scaled limit for MSDUs; and means for configuring the station to transmit the PPDUs in accordance with the uplink recourse allocation for the station.

In Example 48, the subject matter of Example 47 optionally includes where the scaled limit for MSDUs is a minimum MSDU spacing or a minimum average MSDU spacing.

In Example 49, the subject matter of any one or more of Examples 47-48 optionally include the apparatus further including: means for determining the scaled limit for MSDUs based on one from the following group: a number of stations indicated in the uplink resource allocation, a per station density MSDU adjustment included in the trigger frame, or a common density MSDU adjustment included in the trigger frame.

In Example 50, the subject matter of any one or more of Examples 47-49 optionally include ax station.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus of an access point, the apparatus comprising: memory; and processing circuitry coupled to the memory, wherein the processing circuitry is configured to:
encode a trigger frame comprising uplink resource allocations for stations;
configure the access point to transmit the trigger frame to the stations; and
decode physical (PHY) layer convergence procedure (PLCP) protocol data unit (PPDUs) from the stations in accordance with the uplink resource allocations, wherein the PPDUs comprise one or more media access control (MAC) service data units (MSDUs), and wherein the MSDUs from each station are within a scaled limit for MSDUs, wherein the scaled limit for MSDUs is to be determined based on a number of the stations.

2. The apparatus of claim 1, wherein the processing circuitry is further configured to:
encode a frame comprising an access point limit for MSDUs; and
configure the access point to transmit the frame to one or more of the stations, wherein the scaled limit for MSDUs is to be determined further based on the access point limit for MSDUs.

3. The apparatus of claim 2, wherein the access point limit for MSDUs is a minimum MSDU spacing or a minimum average MSDU spacing.

4. The apparatus of claim 1, wherein the scaled limit for MSDUs is determined based on dividing the access point limit for MSDUs by the number of stations indicated in the trigger frame.

5. The apparatus of claim 1, wherein the processing circuitry is further configured to:
determine a density MSDU adjustment based on the number of the stations.

6. The apparatus of claim 1, wherein the trigger frame comprises a common information portion of the uplink resource allocation and the common information portion comprises the density MSDUs adjustment, and wherein the scaled limit for MSDUs is determined based on an access point limit for MSDUs and the density MSDU adjustment.

7. The apparatus of claim 1, wherein the scaled limit for MSDUs is a number of bytes or a time duration.

8. The apparatus of claim 1, wherein the processing circuitry is further configured to:
determine a per station density MSDU adjustment based on the number of stations, and wherein the trigger frame comprises a per user portion of the uplink resource allocation for each station and each per station portion comprises the per station density MSDU adjustment, and wherein the scaled limit for MSDUs is to be determined by each station based on an access point limit for MSDUs and a corresponding scaled limit for MSDUs.

9. The apparatus of claim 1, wherein the scaled limit for MSDUs is a minimum MSDU spacing or a minimum average MSDU spacing.

10. The apparatus of claim 1, wherein one or more of the PPDUs are aggregated PPDUs, and wherein one or more of the PPDUs comprise aggregated MSDUs.

11. The apparatus of claim 1, wherein the processing circuitry is further configured to:
encode acknowledgements or block acknowledgements for the PPDUs received from the stations; and
configure the access point to transmit the acknowledgements or block acknowledgments to the stations.

12. The apparatus of claim 1, wherein the access point and each station of the stations is one from the following group: an institute of Electrical and Electronic Engineers (IEEE) 802.11ax access point, an IEEE 802.11 station, an IEEE access point, a station acting as a group owner (GO), IEEE 802.11az station, IEEE 802.11az access point, and an IEEE 802.11ax station.

13. The apparatus of claim 1, further comprising transceiver circuitry coupled to the memory; and, one or more antennas coupled to the transceiver circuitry.

14. A non-transitory computer-readable storage medium that stores instructions for execution by one or more processors, the instructions to configure the one or more processors to cause an apparatus of an access point to:
encode a physical (PHY) layer convergence procedure (PLCP) protocol data unit (PPDU) for a second access point or a second station, wherein the PPDU are within a scaled limit for media access control (MAC) service data units (MSDUs) of the second access point or the second station; and
configure the first access point or first station to transmit the PPDU.

15. The non-transitory computer-readable storage medium of claim 14, wherein the instructions further configure the one or more processors to cause the apparatus of the access point to:
decode a packet comprising the scaled limit for MSDUs of the second access point or the second station, wherein the packet is from the second access point or the second station.

16. The non-transitory computer-readable storage medium of claim 14, wherein the scaled limit for MSDUs of the second access point is a minimum MSDU spacing or a minimum average MSDU spacing.

17. The non-transitory computer-readable storage medium of claim 14, wherein the scaled limit for MSDUs is to be determined further based on a portion of a bandwidth indicated in the uplink resource allocation for a station of the stations relative to a total bandwidth for the uplink resource allocation.

18. The non-transitory computer-readable storage medium of claim 14, wherein one or more of the PPDUs are aggregated PPDUs, and wherein one or more of the PPDUs comprise aggregated MSDUs.

19. A method performed by an apparatus of an access point, the method comprising:
encoding a trigger frame comprising uplink resource allocations for stations;
configuring the access point to transmit the trigger frame to the stations; and
decoding physical (PHY) layer convergence procedure (PLCP) protocol data unit (PPDUs) from the stations in accordance with the uplink resource allocations, wherein the PPDUs comprise one or more media access control (MAC) service data units (MSDUs), and wherein the PPDUs from each station are within a scaled limit for MSDUs.

20. The method of claim 19, wherein the scaled limit for MSDUs is a minimum MSDU spacing or a minimum average MSDU spacing.

21. An apparatus of a station, the apparatus comprising: a memory; and
processing circuitry coupled to the memory, wherein the processing circuitry is configured to:
decode a trigger frame comprising uplink resource allocations for the station;
determine a scaled limit for media access control (MAC) service data units (MSDUs);
encode physical (PHY) layer convergence procedure (PLCP) protocol data unit (PPDUs) in accordance with the uplink resource allocation for the station, wherein the PPDUs comprise one or more MSDUs, and wherein the MSDUs are within the scaled limit for MSDUs; and
configure the station to transmit the PPDUs in accordance with the uplink recourse allocation for the station.

22. The apparatus of claim 21, wherein the scaled limit for MSDUs is a minimum MSDU spacing or a minimum average MSDU spacing.

23. The apparatus of claim 21, wherein the processing circuitry is further configured to:
determine the scaled limit for MSDUs based on one from the following group: a number of stations indicated in the uplink resource allocation, a per station density MSDU adjustment included in the trigger frame, or a common density MSDU adjustment included in the trigger frame.

24. The apparatus of claim 21, wherein the station and the access point is one from the following group: an Institute of Electrical and Electronic Engineers (IEEE) 802.11ax access point, an IEEE 802.11 station, an IEEE access point, a station acting as a group owner (GO), and an IEEE 802.11ax station.

25. The apparatus of claim 21, further comprising transceiver circuitry coupled to the memory; and, one or more antennas coupled to the transceiver circuitry.
